(19) United States
(12) Patent Application Publication
(10) Pub. No.: US 2014/0065886 A1
(43) Pub. Date: Mar. 6, 2014

(54) Multi-Standard Socket Adaptor

(71) Applicant: Chiu-San LEE, New Taipei City (TW)

(72) Inventor: Chiu-San LEE, New Taipei City (TW)

(21) Appl. No.: 13/603,398

(22) Filed: Sep. 4, 2012

(51) Int. Cl. H01R 31/06

(52) U.S. Cl. 439/628

(57) ABSTRACT

The present invention provides a multi-standard socket adaptor, comprising at least one socket interface and a housing attached to the socket interface. The internal of the housing comprises a first terminal set and a second terminal set conforming to the 125-volt and 250-volt socket specifications respectively; wherein the socket adaptor further comprises a first socket set and a second socket set corresponding to the first and second terminal sets respectively as well as confirming to the 125-volt and 250-volt socket specifications. The second terminal set can be used for voltage input and output of 125-volt. With such structure, socket heads of 125-volt and 250-volt can be plugged into corresponding sockets on the socket adaptor achieving said voltage outputs and inputs and to improve the practical usage of the socket adaptor conforming to international standards of various countries including the ones in German and France.

### TECHNICAL FIELD OF THE INVENTION

The present invention is related to a standard socket adaptor, in particular, to a multi-standard socket adaptor capable of providing sockets adapted to various standards of socket heads around the globe including the ones for the countries of German and France, which also conforms to the voltage standards of 125-volt and 250-volt socket specifications, achieving greater practical uses and applications thereof.

### DESCRIPTION OF THE PRIOR ART

In view of common universal socket adapts provided for appliances around the globe, the problem associated with the incorrect matches among different terminals and standards often occurs; in other words, a number socket heads of certain standards cannot be fitted to the socket adaptor.

As the technology of electronic devices improves rapidly, most of the electronic devices are designed to consumed less energy; therefore, the wall plugs designed for traditional usages are not sufficient in meeting the current uses. There is a need to improve the electrically connections of electric sockets among various different standards and to cope for multiple plug-ins.

However, unsafe usage of traditional socket adaptors occurs often. One must consider the quality of the socket, the terminals to be matched or to cooperate with the socket heads for plug-ins and the tightness of the plug-ins as well as the capacity of loading on the electrically charged surface area in order to ensure the safety of the usage. As the material costs continues to rise high with uncertainties, it is necessary to design a socket adaptor taking into account of the importance of energy saving concerns as well as the quality and efficiency of the usage in order to facilitate the use of the socket adaptors in various fields and among different connections thereto.

It is clear that an electrical socket adaptor providing for both the plug-ins of the sockets of 125 volt and 250 volt is currently unavailable in the market; therefore, having an electrical connection conforming to the standards of different countries and their electrical specifications as well as electrical applications at the same time can be troublesome, which cannot be achieved easily while introduces greater burdens to the users.

### SUMMARY OF THE INVENTION

In view of the abovementioned drawbacks of the prior socket adaptors, with years of research and development in the same industry and experience, the inventor designs and provides a multi-standard socket adaptor capable of adapting to socket heads of international standards of various countries and providing sockets for the inputs and outputs of 125-volt and 250-volt.

The primary objective of the present invention is to: integrate electric sockets conforming to both 125-volt and 250-volt socket specifications into one single socket adaptor. The socket adaptor is provided with a voltage indication lamp to prevent the plugging in of 125-volt socket head to the socket for 250-volt such that users can plug in different socket heads into the socket adaptor according to standards and voltages of different countries in order to achieve the safety and practical usages of the socket adaptor.

To achieve the objective recited above, the present invention provides a multi-standard socket adaptor, comprising at least one socket interface and a housing attached to said socket interface, and an internal of said housing comprises a first terminal set and a second terminal set conforming to a 125-volt and a 250-volt socket specification respectively; wherein said socket adaptor comprises a first socket set and a second socket set corresponding to said first terminal set and said second terminal set respectively as well as conforming to said 125-volt socket specification and said 250-volt socket specification respectively. The first socket set and the second socket set respectively comprise a first live line of a L terminal, a first naught line of a N terminal and a first earth line of an E terminal, a second live line of a L terminal, a second naught line of a N terminal and a second earth line of an E terminal. Furthermore, the housing further comprises a first connecting port electrically connected to the first terminal set and conforming to the 125-volt socket specification and a second connecting port electrically connected to the second terminal set and conforming to either the 125-volt or the 250-volt socket specification. In addition, the second terminal set is electrically connected to a joining portion.

With the abovementioned structures and configurations, the socket adaptor of the present invention provides a design for both the plug-in of the input and output voltages of 125-volt and 250-volt such that users can correctly and safely plug the socket heads of 125-volt and 250-volt into the corresponding sockets and such that the practical and safe usages of socket adaptors conforming to international standards of various countries including the ones for German and France can be achieved.

### BRIEF DESCRIPTION OF THE DRAWINGS

FIG. 1 is a perspective view of a first preferred embodiment of the present invention;

FIG. 2 is a first illustration showing an implementation of the first preferred embodiment of the present invention;

FIG. 3 is a second illustration showing an implementation of the first preferred embodiment of the present invention;

FIG. 4 is a third illustration showing an implementation of the first preferred embodiment of the present invention;

FIG. 5 is a fourth illustration showing an implementation of the first preferred embodiment of the present invention;

FIG. 6 is a fifth illustration showing an implementation of the first preferred embodiment of the present invention;

FIG. 7 is a sixth illustration showing an implementation of the first preferred embodiment of the present invention;

FIG. 7A is a seventh illustration showing an implementation of the first preferred embodiment of the present invention;

FIG. 8 is a first illustration showing an implementation of a second preferred embodiment of the present invention; and

FIG. 9 is a second illustration showing an implementation of the second preferred embodiment of the present invention.

### DETAILED DESCRIPTION OF THE PREFERRED EMBODIMENTS

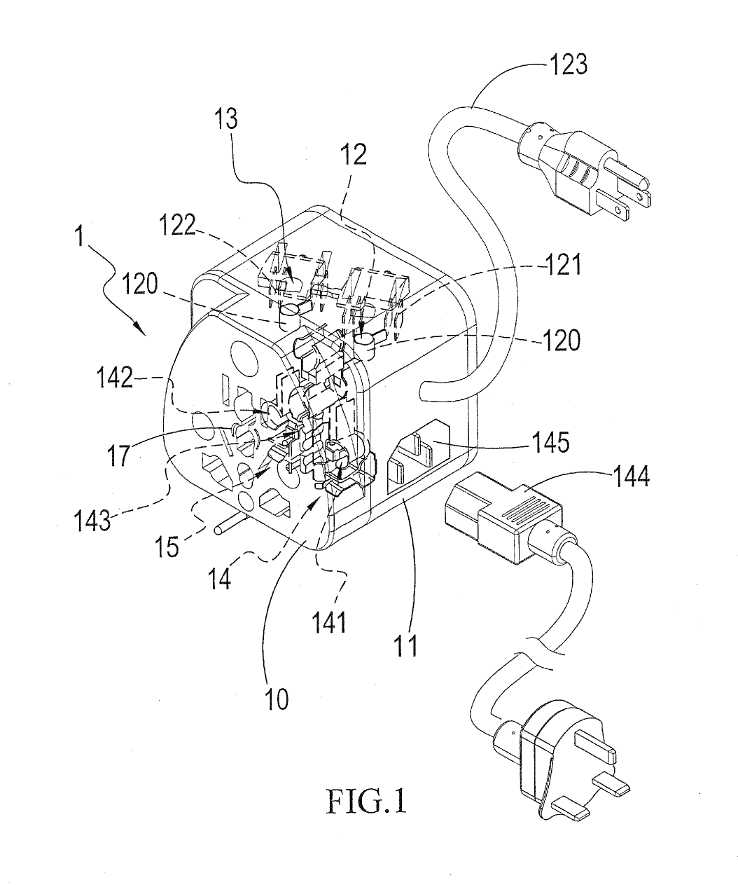

FIG. 1 shows a perspective view of a first preferred embodiment of the present invention. As shown in the figures, the multi-standard socket adaptor 1 of the present invention comprises at least one socket interface 10 and a housing 11 attached to said socket interface 10; wherein said socket adaptor 1 comprises:

at least one first terminal set 12 conforming to a 125-volt socket specification, provided in an internal of said housing 11; wherein said first terminal set 12 is defined with a first live line of a L terminal 121, a first naught line of a N terminal 122 and a first earth line of an E terminal 120;

at least one first socket set 13 conforming to a 125-volt socket specification, cooperating with said first terminal set 12;

at least one second terminal set 14 conforming to a 250-volt socket specification, provided in an internal of said housing 11; wherein said second terminal set 14 is defined with a second live line of a L terminal 141, a second naught line of a N terminal 142 and a second earth line of an E terminal 143;

at least one second socket set 15 conforming to a 250-volt socket specification, cooperating with said second terminal set 14.

According to the abovementioned structure and configuration, wherein the housing 11 comprises a first connecting port 123 electrically connected to said first terminal set 12 and conforming to said 125-volt socket specification as well as a second connecting port 145 electrically connected to said second terminal set 14 and conforming to said 250-volt socket specification. The second connecting port 140 is also electrically connected to a power supply line 144 conforming to the 250-volt socket specification. Furthermore, aid second terminal set 14 extends outward to penetrate through said socket interface 10 to form a grounding portion 17 conforming to the standards for grounding in German and France.

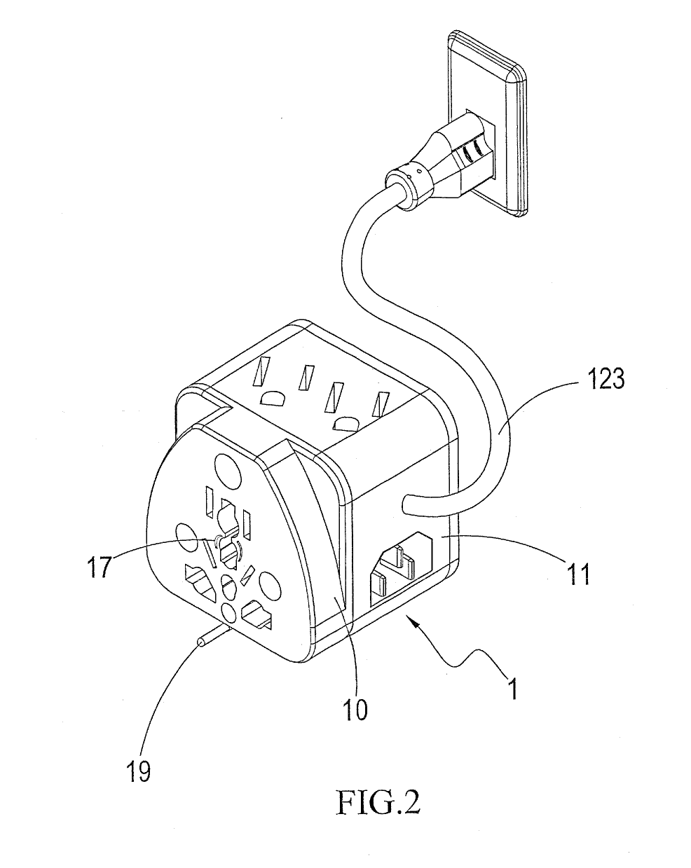

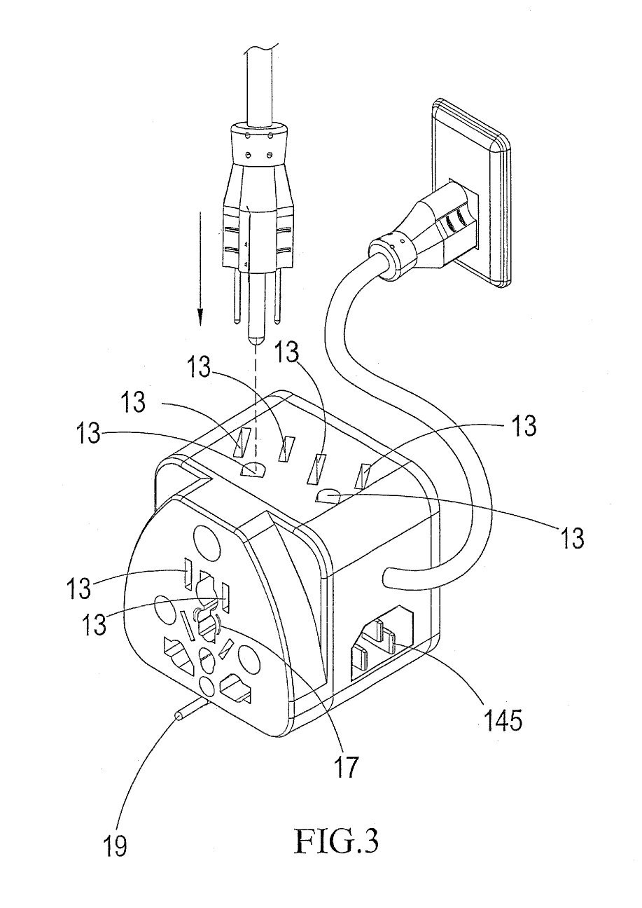

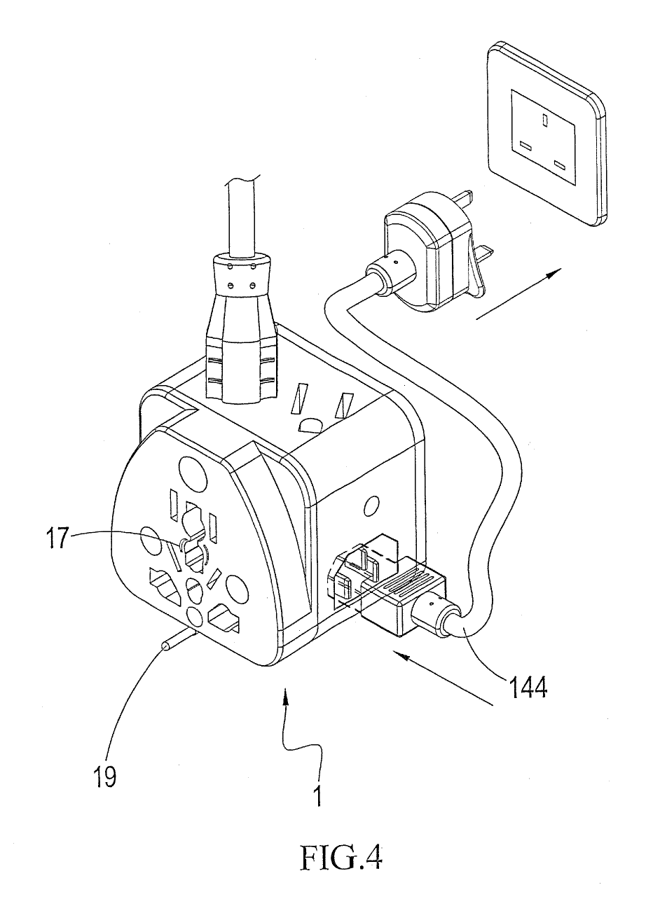

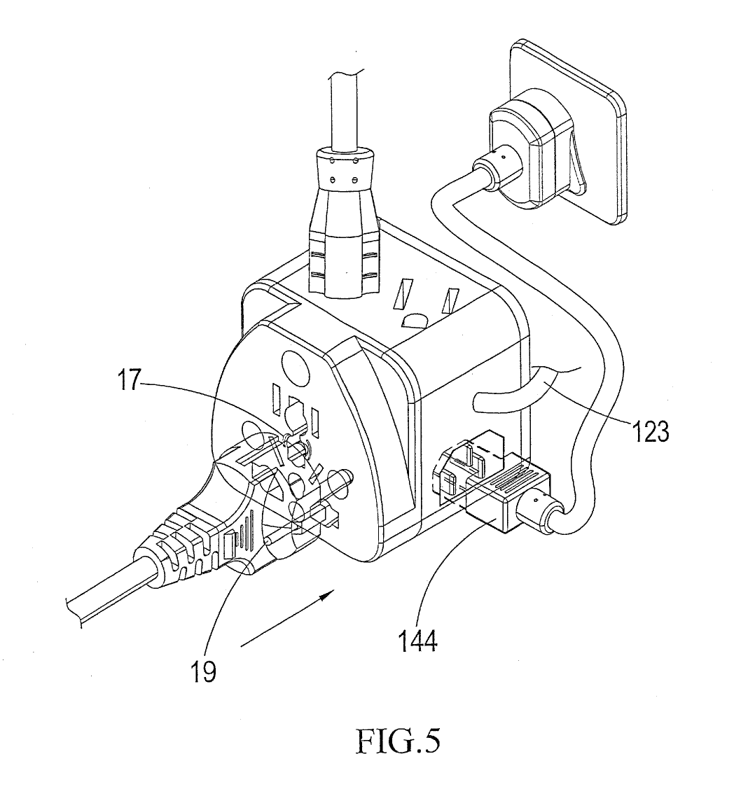

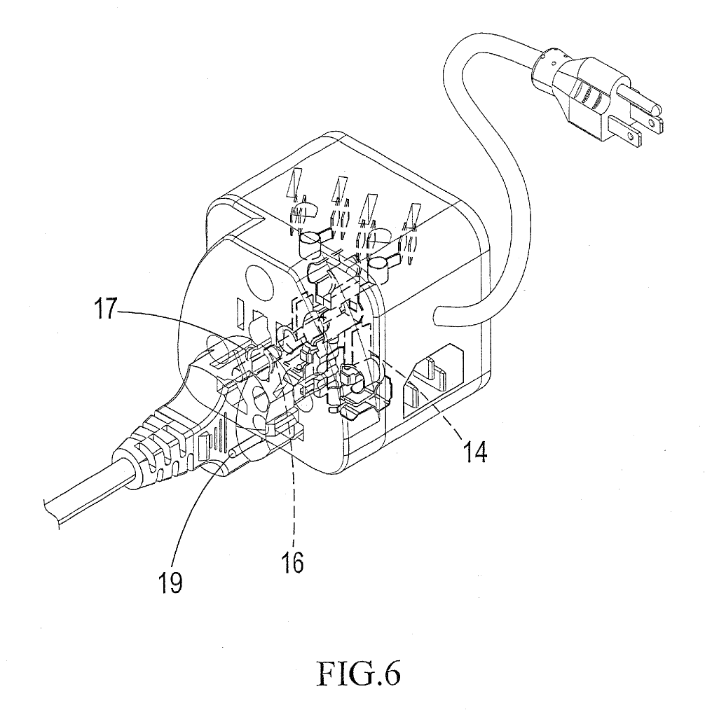

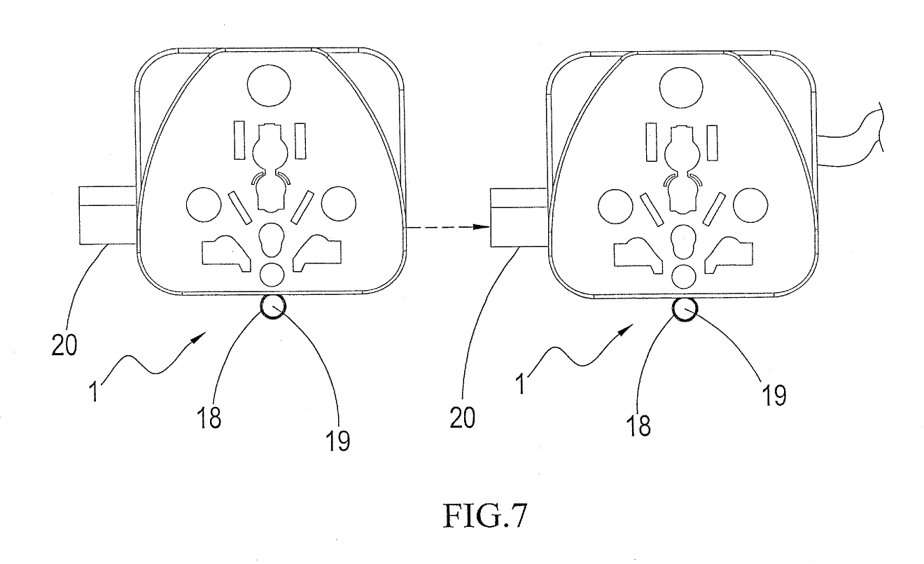

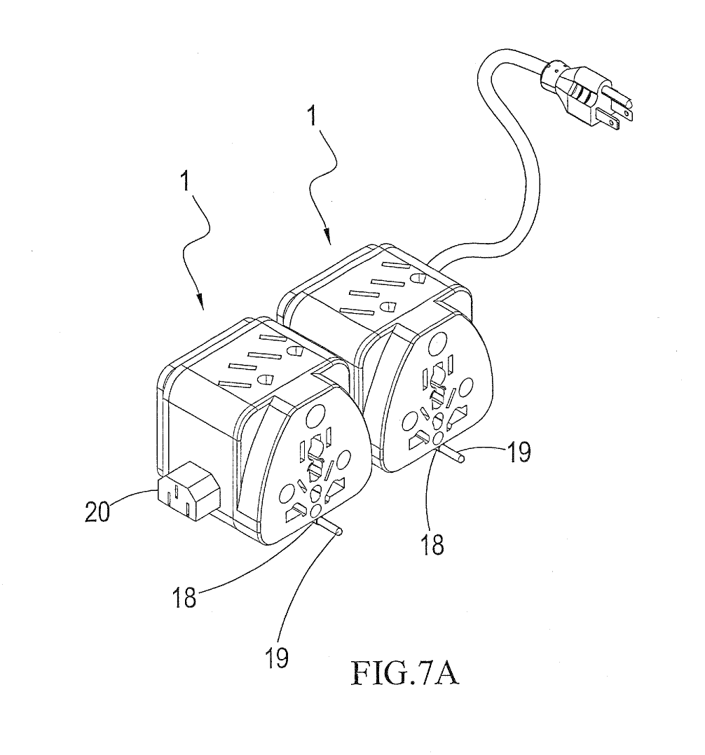

In view of the structure and assembled design recited above, the following further describes the operation and cooperation of the present invention in practice. As shown in FIGS. 2 to 7A, referring to as the first to seventh implementation illustrations of the first preferred embodiment of the present invention, it is clear that the socket adaptor 1 comprises a socket interface 10 and a housing attached to the socket interface 10. As an user is to perform the implantation or to practice the invention, he or she can plug in a socket head conforming to the 125-volt socket specification into the first connecting port 124 and to electrically connect the first connecting port 123 with the corresponding power supply base of 125-volt, following which, the user can then plug in the socket head conforming to the 125-volt socket specification into the first socket set 13 provided on the socket adaptor 1 in order to achieve the electrical connection thereof. On the other hand, the user can also connect a power supply line 144 to the second connecting port 145 provided on the housing 11; wherein the power supply line 144 can be of a separated design. The power supply line 144 is electrically connected to the power supply base of 250-volt correspondingly. The electrical output and input thereof can all be 125-volt depending on the desired output and input requirements to form a voltage of 125-volt. Following which, the user can plug in the socket head conforming to the 250-volt socket specification into the socket adaptor 1 of the present invention, and in addition, proper connections between the socket heads and the socket as well as the terminals thereof can be achieved via the joining portion 16 attached to the second terminal set 14. The abovementioned joining portion 16 can be either a flexible part or a column part. In addition, the first socket set 13 can be a multiple of sets. With the structural operations and configurations recited above, it is clear that the socket adaptor of the present invention is capable of providing electrical outputs and inputs for sockets and sockets heads conforming to both the 125-volt and 250-volt socket specifications, achieving and improving the safety and practical usages of the socket adaptor conforming to international standards of various countries. According to the abovementioned structure and configuration, the second terminal set 14 of the present invention extends outward to penetrate through the socket interface 10 to form a grounding portion 17 conforming to the standards for grounding in

German and France. As the user plug in the socket heads corresponding to the specification of German and France, proper grounding can be achieved in practice. Furthermore, the socket adaptor 1 of the present invention is capable of cooperating with the first connecting port 123 for operation thereof. In addition, the socket adaptor 1 of the present invention can also cooperate with an extension for operation thereof by attaching the corresponding portion 20 provided on one side of the housing 11 to the second connecting port 145 in order to achieve a repeated configuration and implementation for operation thereof in practice. Also, a enforced grounding portion 18 is provide on an external wall of the socket adaptor 1, an a joining rod 19 having a collapsed form and provided on the enforced grounding portion 18 can be further electrically connected to the second earth line of the E terminal. Therefore, regardless of the directions of the plugin of the socket heads, proper groundings can be achieved via the enforced grounding portion 18 and the joining rod 19 such that the electrical connections adapted to the socket heads of the standards of German and France can be achieved.

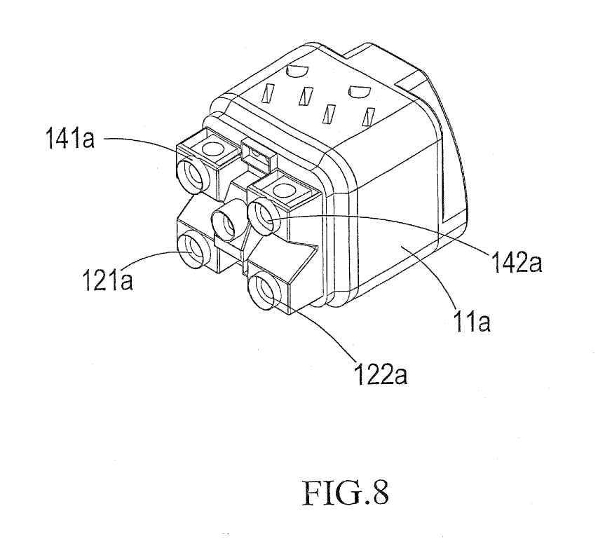

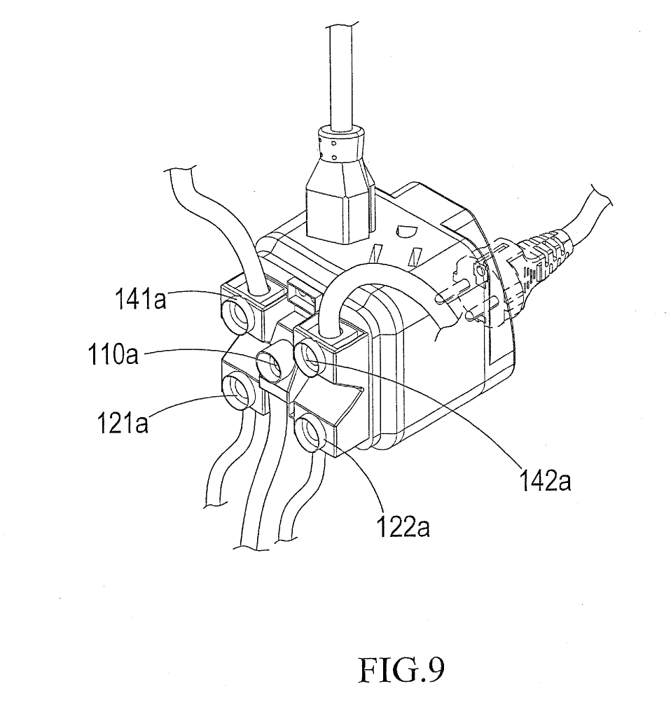

FIGS. 8 and 9 are first and second implementation illustrations of a second preferred embodiment of the present invention. In accordance with the abovementioned first embodiment, the present invention provides a connecting portion 110a arranged on one side of the housing 11 a comprising at least one first live line of a L terminal 121a, a first naught line of a N terminal 122a, a second live line of a L terminal 141a and a second naught line of a N terminal 142. Users can interconnect to form electrical connections between the power lines buried in the wall and the connecting portions 11a to achieve the second embodiment of the present invention. As one may understand that the operations and implementations of the second embodiment are substantially the same as the ones of the first embodiment, related descriptions are therefore omitted.

What is claimed is:

1. A multi-standard socket adaptor, comprising at least one socket interface and a housing attached to said socket interface; wherein said socket adaptor comprising:
at least one first terminal set conforming to a 125-volt socket specification, provided in an internal of said housing; wherein said first terminal set is defined with a first live line of a L terminal, a first naught line of a N terminal and a first earth line of an E terminal;
at least one first socket set conforming to a 125-volt socket specification, cooperating with said first terminal set;
at least one second terminal set conforming to a 250-volt socket specification, provided in an internal of said housing; wherein said second terminal set is defined with a second live line of a L terminal, a second naught line of a N terminal and a second earth line of an E terminal; and wherein said second terminal set extends outward to penetrate through said socket interface to form a grounding portion; and
at least one second socket set conforming to a 250-volt socket specification, cooperating with said second terminal set.

2. The multi-standard socket adaptor according to claim 1, wherein said housing comprises a first connecting port electrically connected to said first terminal set and conforming to said 125-volt socket specification.

3. The multi-standard socket adaptor according to claim 1, wherein said housing comprises a second connecting port electrically connected to said second terminal set and conforming to said 125-volt or said 250-volt socket specification.

4. The multi-standard socket adaptor according to claim 3, wherein said second connecting port is connecting port electrically connected to a power supply line conforming to said 250-volt socket specification.

5. The multi-standard socket adaptor according to claim 1, wherein one side of said housing opposite from said socket interface thereof comprises at least one connection portion corresponding to said first terminal set and said second terminal set.

6. The multi-standard socket adaptor according to claim 1, wherein one side of said housing comprises a corresponding portion.

7. The multi-standard socket adaptor according to claim 1, wherein said second terminal set is electrically connected to a joining portion provided thereon.

8. The multi-standard socket adaptor according to claim 7, wherein said joining portion is selected from one of a flexible part or a column part.

9. The multi-standard socket adaptor according to claim 1, wherein one side of said socket adaptor comprises a enforced grounding portion, and said enforced grounding portion further comprises a joining rod electrically connected to said second earth line of the E terminal.
